(19) United States
(12) Patent Application Publication
(10) Pub. No.: US 2025/0191192 A1
(43) Pub. Date: Jun. 12, 2025

(54) METHOD AND SYSTEM FOR IMAGE PROCESSING

(71) Applicant: Centre for Intelligent Multidimensional Data Analysis Limited, Pak Shek Kok (HK)

(72) Inventors: Tak Wu Sam Kwong, Pak Shek Kok (HK); Jinpeng Chen, Pak Shek Kok (HK); Runmin Cong, Pak Shek Kok (HK)

(21) Appl. No.: 18/536,385

(22) Filed: Dec. 12, 2023

(51) Int. Cl. G06T 7/12; G06T 5/20; G06V 10/44; G06V 10/46; G06V 10/80

(52) U.S. Cl. CPC G06T 7/12; G06T 5/20; G06V 10/44; G06V 10/462; G06V 10/806

(57) ABSTRACT

A computer-implemented method of image processing to identify one or more objects in an image including receiving one or more input images, wherein each input image includes one or more salient instances, wherein each salient instance is indicative of an object, identifying a plurality of key points associated with each salient instance within each input image, segmentation of salient instances in each image by utilizing the plurality of key points, wherein the key points include a centre point and peripheral points of each salient instance, and predicting one or more objects within each image based on the segmentation of each salient instance.

### TECHNICAL FIELD

The present invention relates to a method and system for image processing for identification of one or more objects in the image.

### BACKGROUND

Image processing has been a technology area of rapid development. Object recognition refers to a process of detecting one or more objects in digital image data (i.e., in digital images). Object recognition within images (or in a stream of images) can be important and is applicable in many areas such as for example in robotics, computer vision, AI driven image analysis tools etc.

Object recognition can involve a bottom-up strategy or a top-down strategy. In a bottom-up strategy. Several models using either a bottom-up strategy or top-down strategy have been developed. However, these known models often utilise approaches that may be too computationally expensive (i.e., resource intensive) or may not be as accurate as required. This can limit the widespread usage of such models.

### SUMMARY OF THE INVENTION

In accordance with a first aspect, the present invention relates to a computer-implemented method of image processing to identify one or more objects in an image, comprising the steps of: receiving one or more input images, wherein each input image includes one or more salient instances, wherein each salient instance is indicative of an object, identifying centre points of one or more salient instances within each received image, identifying a plurality of peripheral points associated with each salient instance within each input image, segmentation of salient instances in each image by utilizing the plurality of key points, wherein the key points comprise a centre point and peripheral points of each salient instance, and; predicting one or more objects within each image based on the segmentation of each salient instance.

At least one embodiment of the present invention has the advantage of providing an improved segmentation due to identification of key point features including a central features and peripheral features that provides improved segmentation. Further a saliency score from a saliency map is used to further improve the recognition of saliency, i.e., whether an instance is salient or not.

In one example the method comprising the steps of: generating a plurality of segmentation filters, applying the segmentation filters to generate masks for each salient instance, and segmenting the one or more images based on the generated masks to identify the one or more objects within each image.

In one example the method comprising the steps of: generating an instance agnostic saliency map for one or more received images, computing a saliency score for each instance, and; utilizing the saliency score to update the one or more identified objects.

In accordance with a further aspect, the present invention relates to a system for image processing to identify one or more objects in an image, comprising:
an image gateway to receive one or more input images, wherein each input image includes one or more salient instances, wherein each salient instance is indicative of an object,
a multi-level feature extraction module configured to identify one or more features within each image and identify one or more instances in the one or more received images,
a key points guided dynamic convolution module configured to:
identify a plurality of key points associated with each salient instance within each input image, wherein the key points comprise a centre point and peripheral points of each salient instance,
segment salient instances in each image by utilizing the plurality of key points, and;
predict one or more objects within each image based on the segmentation of each salient instance.

In one example the system comprises: a semantic guidance saliency module configured to: estimate a saliency map from identified features, compute a saliency score based on the saliency map. The system may further comprise a prediction module configured to: update the predicted one or more objects from the key points guided dynamic convolution module and; generate an updated prediction of one or more objects within each image.

In another aspect, there is provided a system for image processing to identify one or more objects in an image, comprising:
an image gateway to receive one or more input images, wherein each input image includes one or more salient instances, wherein each salient instance is indicative of an object,
a multi-level feature extraction module configured to identify one or more features within each image and process the extracted features with multiple instance aware heads,
a key points guided dynamic convolution module configured to:
identify a plurality of key points associated with each salient instance within each input image, wherein the key points comprise a centre point and peripheral points of each salient instance,
segment salient instances in each image by utilizing the plurality of key points, and; predict one or more objects within each image based on the segmentation of each salient instance.

The multi-level feature extraction module may be configured to identify one or more instances within the one or more received images.

In one embodiment, the key points guided dynamic convolution module configured to:
identify a centre point for each salient instance,
generate a first set of dynamic convolution filters based on the identified centre point, predict a minimum number of peripheral points using the dynamic convolution filters, and;
wherein the minimum number of peripheral points denote the limits of the instance in four directions.

In one embodiment, the bottom module configured to generate bottom features for each of the received images, wherein the bottom features are generated based on outputs from a feature pyramid network and;
the key points guided dynamic convolution module is further configured to concatenate and convolute the bottom features by the first set of dynamic convolution filters to predict the peripheral points.

In one embodiment, wherein key points guided dynamic convolution module further configured to:
generate a plurality of segmentation filters,
apply the segmentation filters to generate masks for each salient instance, and;
segment the one or more images based on the generated masks to identify the one or more objects within each image.

In one embodiment, the system further comprises a semantic guidance saliency module configured to: estimate a saliency map from identified features, compute a saliency score based on the saliency map, a score adjustment module configured to update an original classification score, a prediction module configured to:
update the predicted one or more objects from the key points guided dynamic convolution module and;
generate an updated prediction of one or more objects within each image.

In one embodiment, the key points guided dynamic convolution module is configured to:
select central features at the centre point or adjacent the centre point,
identify peripheral features at the peripheral points or adjacent the peripheral points based on their difference from the central features,
compute distance vectors between the peripheral features and the central features, determine a weighted average of the peripheral features,
the key points guided dynamic convolution module further comprises a differentiated patterns fusion module that is configured to:
compute weights for the peripheral features, wherein the weights are computed based on the distance vectors,
combine the peripheral features based on the computed weights,
average the combined peripheral features with the central features and then reshaped to generate the set of segmentation filters, and;
the key points guided dynamic convolution module is configured to concatenate the bottom features with related coordinates with the centre point and utilize the concatenated bottom features to output the masks. Optionally the concatenated bottom features may be used alongside segmentation filters to output the masks.

In accordance with a further aspect, the present invention relates to machine-learning model for image processing to identify one or more objects in an image for use in the method as described above. The model may be stored in and executed by the system for image processing.

### BRIEF DESCRIPTION OF THE PREFERRED EMBODIMENTS

Embodiments of the present invention will now be described, by way of example, with reference to the accompanying drawings in which:

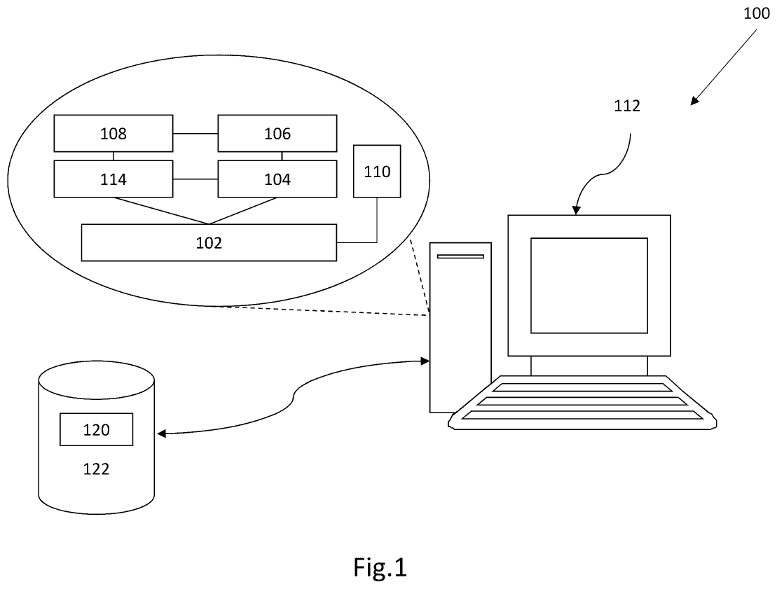

FIG. 1 illustrates a schematic diagram of a computing device which is arranged to implement an example embodiment of a system for image processing to identify one or more objects.

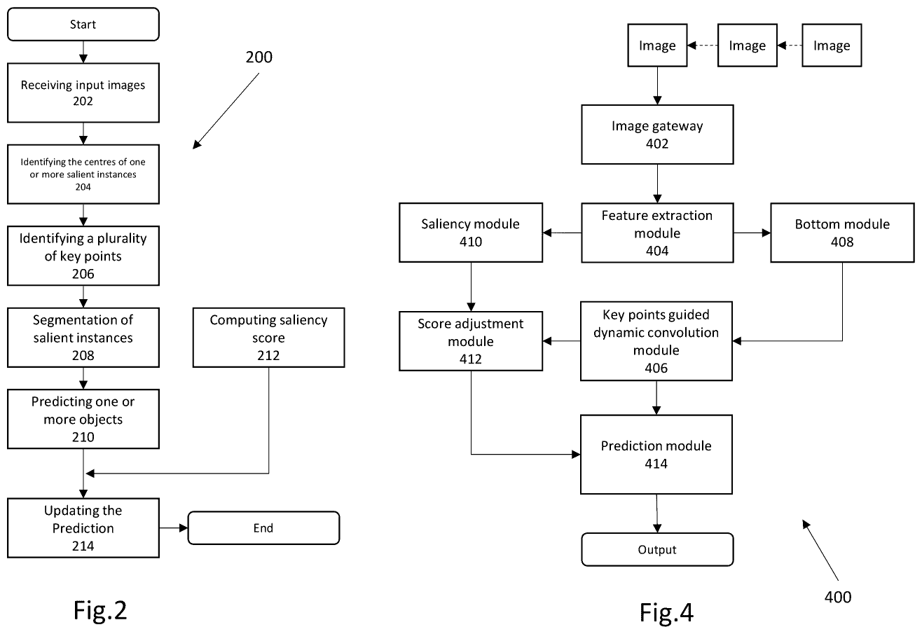

FIG. 2 illustrates an example of a method for image processing to identify one or more objects in an image.

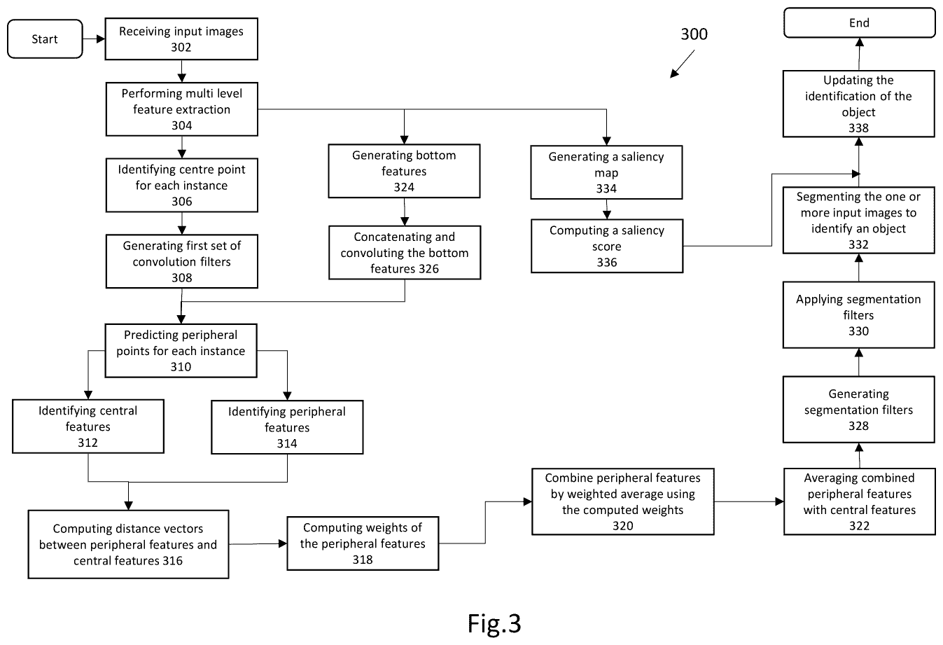

FIG. 3 illustrates a further example of a method for image processing to identify one or more objects in an image.

FIG. 4 illustrates an example system for image processing to identify one or more objects in the image.

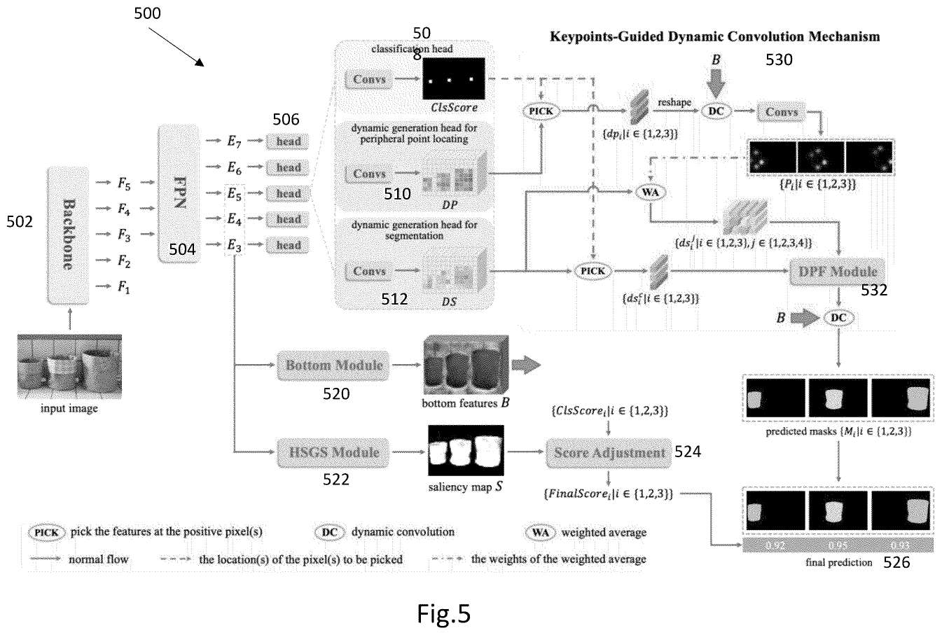

FIG. 5 illustrates a schematic diagram of an example machine-learning model for image processing.

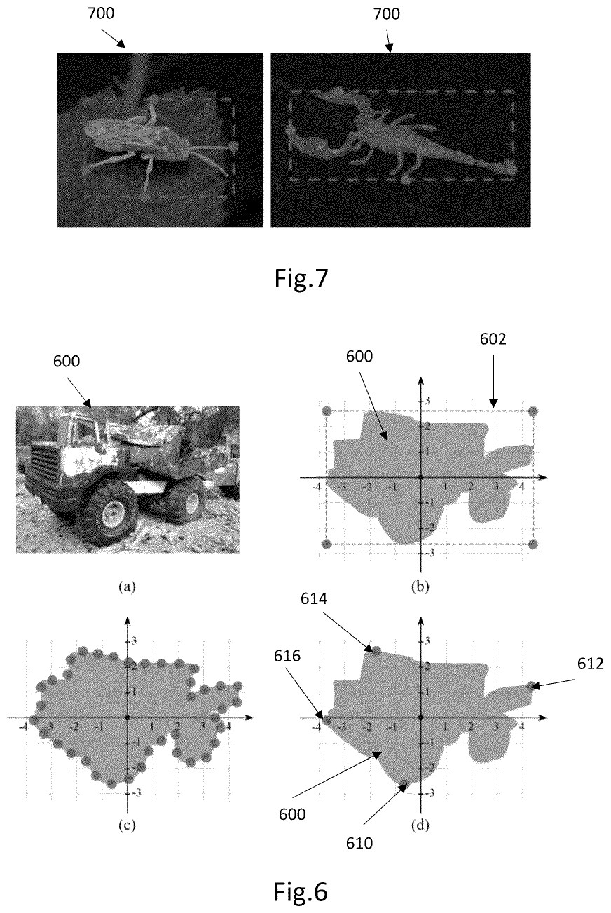

FIG. 6, at part a), illustrates an image with an object; at part b), illustrates a prior art approach of forming a bounding box vertex of the object; at part c), illustrates peripheral points defining the shape of the object; and at part d) illustrates the minimum number of peripheral points used to identify an object.

FIG. 7 illustrates the effectiveness of peripheral points to fully delineate even complex objects.

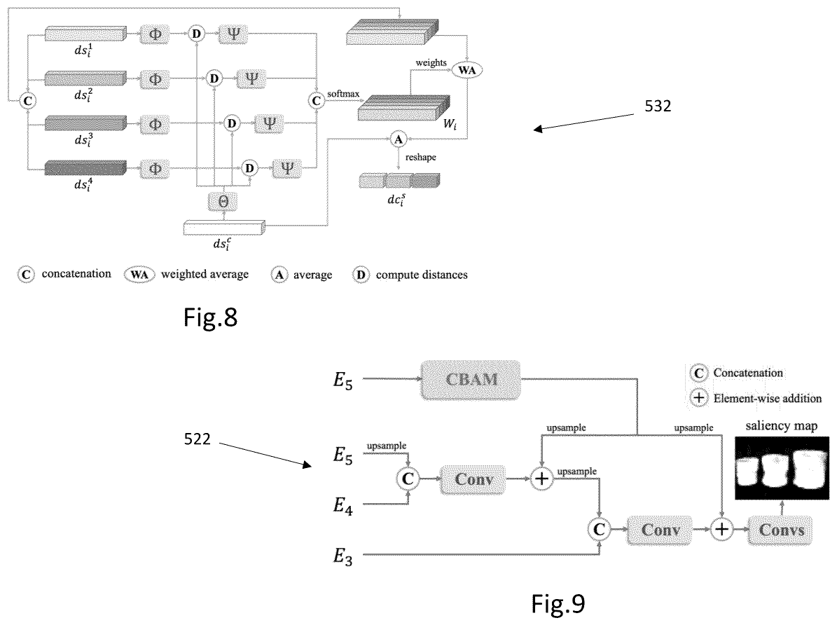

FIG. 8 illustrates an example structure of the differentiated patterns fusion (DPF module.

FIG. 9 illustrates an example structure of the semantic guided saliency module.

### DETAILED DESCRIPTION OF THE PREFERRED EMBODIMENTS

In one example the present invention relates to a method and system for improved image processing, and particularly, but not limited to a method and system for image processing comprising identification of one or more objects (instances) in the image utilising salient instance segmentation based on a plurality of key point features. The key point features are used to identify salient instances e.g., objects within the image. The multiple key point features are used to provide improved i.e., high quality masks for the salient instances within the images.

In one example the present invention relates to a method of image processing for identification of one or more objects comprising the steps of: receiving one or more input images, wherein each input image includes one or more salient instances, wherein each salient instance is indicative of an object, identifying one or more salient instances within each received image, identifying a plurality of key points associated with each salient instance within each input image, segmentation of salient instances in each image by utilizing the plurality of key points, and; predicting one or more objects within each image based on the segmentation of each salient instance. The key points comprise a centre point and peripheral points of each salient instance. The method further comprises the steps of generating a saliency map the one or more received images, computing a saliency score for each instance, and; utilizing the saliency score to update the one or more identified objects.

In a further example the present invention relates to a system for image processing to identify one or more objects in an image, comprising: an image gateway to receive one or more input images, wherein each input image includes one or more salient instances, wherein each salient instance is indicative of an object, a multi-level feature extraction module configured to identify one or more features within each image, a key points guided dynamic convolution module configured to: identify a plurality of key points associated with each salient instance within each input image, wherein the key points comprise a centre point and peripheral points of each salient instance, segment salient instances in each image by utilizing the plurality of key points, and; predict one or more objects within each image based on the segmentation of each salient instance. The system may further include a semantic guidance saliency module configured to: estimate a saliency map from identified features, compute a saliency score based on the saliency map. The system may comprise a score adjustment module configured to update an original classification score and a prediction module configured to: update the predicted one or more objects from the key points guided dynamic convolution module and; generate an updated prediction of one or more objects within each image. In this example the key points comprise centres and peripheral points for one or more salient instances within each received image.

The described system and method for image processing may be implemented by a, computing device (i.e., a computer or computer apparatus) having at least a processing unit, memory and an appropriate user interface. The computing device may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the method and system for image processing to identify one or more objects.

The computing device (i.e., computer or computing apparatus) may be implemented as a microprocessor or microcontroller within other devices such as for example cars, autonomous driving vehicles, drones, robots or cameras. The system and method for image processing may be embodied as software that may be implemented as part of AI driven image analysis tools or executable applications encompassing image processing and recognition. The system, method and model described herein can be used for image captioning for scene understanding where analysis of salient instances can be important. The terms computing device, computer, computing apparatus and variations thereof can denote any hardware product that comprises at processing unit, memory unit and other components that can be used to implement the method and system for image processing for object recognition as described herein, and any suitable architecture.

In this embodiment, the system and method are arranged to process one or more received images based on utilising salient instance segmentation using key points and key point features to enhance the accuracy of mask prediction and the reliability of the confidence score. The system, method and model described herein are advantageous because it utilises multiple key point features and utilises saliency score adjustment to provide improved object recognition.

As shown in FIG. 1 there is a shown a schematic diagram of a computing device (i.e., a computer or a computing apparatus) 100 which is arranged to be implemented as an example embodiment of a system for image processing to identify one or more objects. The computing device 100 includes suitable components necessary to receive, store and execute appropriate computer instructions. The components may include a processing unit 102, including Central Processing Unit (CPU), Math Co-Processing Unit (Math Processor), Graphic Processing Unit (GPUs) or Tensor processing unit (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114. The computing device 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The computing device 100 may include storage devices such as a disk drive 108 which may encompass solid state drives, hard disk drives, optical drives, magnetic tape drives or remote or cloud-based storage devices. The computing device 100 may use a single disk drive or multiple disk drives, or a remote storage service. The computing device 100 may also have a suitable operating system which resides on the disk drive or in the ROM of the computing device 100.

The computing device 100 (i.e., computing apparatus or computer) may also provide the necessary computational capabilities to operate or to interface with a machine learning network, such as a neural network, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The computing device 100 may be configured to implement a machine learning model (i.e., a machine learning network) 120 for image processing to identify one or more objects in an image. The learning model 120 may be stored in a memory unit e.g., ROM 104, RAM 106 or a disk drive 108. Alternatively, the model 120 may be stored in a database 122 along with additional libraries and data. The machine learning model 120 is configured to implement the method of image processing to identify one or more objects. The method may be as per the method described herein.

FIG. 2 illustrates an example of a method 200 for image processing to identify one or more objects in an image. The method 200 may be executed by the computing device 100. The method 200 commences at step 202. Step 202 comprises receiving one or more input images, wherein each input image includes one or more salient instances, wherein each salient instance is indicative of an object.

Step 204 comprises identifying one or more salient instances within each received image.

Step 206 comprises identifying a plurality of key points associated with each salient instance within each input image. Key points may comprise centre points and peripheral points of each instance identified in an image. For example, step 206 may comprise identifying centre points and peripheral points of each instance identified in each received image.

Step 208 comprises segmentation of salient instances in each image by utilizing the plurality of key points, wherein the key points comprise a centre point and peripheral points of each salient instance. Step 210 predicting one or more objects within each image based on the segmentation of each salient instance.

The peripheral points define the bounds of an instance regardless of the shape of the instance and further define preliminary geometrical information that is infused in the segmentation filters.

The method 200 may further comprise step 212. Step 212 comprises computing a saliency score based on a determined saliency map. The saliency map may be estimated from features identified in the one or more input images. Step 214 comprises updating the identified salient instances by the segmentation. The predicted instances are updated using the saliency score to further enhance the perception of saliency and to provide an improved output of object detection.

The method 200 may be defined as executable instructions in the form of a software application or a software program. The method 200 may be repeated continuously. The method 200 may be performed each time the software application or software program is executed.

A data processing apparatus for image processing to identify one or more objects in an image, such as computing device 100 may comprise: a processing unit and a memory unit comprising executable instructions, which when executed by the processing unit causes the processing unit to carry out method steps 202 to 214. Optionally, the method may comprise the additional step of determining an object or instance in each image. The instance may be detected by using a multi-level feature extraction and processing extracted features with multiple instance heads.

FIG. 3 illustrates another example a method 300 for image processing to identify one or more objects in an image. The method 300 commences at step 302. Step 302 comprises receiving one or more input images, wherein each input image includes one or more salient instances, wherein each salient instance is indicative of an object.

Step 304 comprises performing a multi-level feature extraction on the received images to extract multiple features. The extracted features may be processed with multiple instance aware heads. Step 306 comprises identifying a centre point for each salient instance. Step 308 comprises generating a first set of dynamic convolution filters based on the identified centre points.

Step 310 comprises predicting a plurality of peripheral points for each salient instance using the dynamic convolution filters. The dynamic convolution filters may be used to convolute the centre points to predict the peripheral points. The method is configured to predict a minimum number of peripheral points per instance. The minimum number of peripheral points denote the limits of the instance in four directions. In one example the minimum number of peripheral points is four peripheral points, the four peripheral points defining the upper most point, bottom most point, left most point and right most point of an instance.

Step 312 comprises identifying central features at or adjacent the identified centre point. The central features may relate to features of the salient instance. Step 314 comprises identifying peripheral features at or adjacent the peripheral points based on the difference from the central features. Step 316 comprise computing the distance vectors between the peripheral features and the central features. The distance vectors may be computed based on the determined distance e.g., pixel distance between the identified peripheral features and the central feature for each instance.

Step 318 comprises computing weights for the peripheral features, wherein the weights are computed based on the distance vectors. The weights may be defined based on the difference between the peripheral features and central features. Step 320 comprises combining the peripheral features by weighted average using the computed weights. Step 322 comprises averaging the combined peripheral features with the central features and then reshaped to generate the set of segmentation filters.

The method comprises an instance agnostic pathway that is also performed. Bottom features are extracted in a bottom module. Step 324 comprises generating bottom features for each of the received images, wherein the bottom features are generated based on outputs from a feature pyramid network. The feature pyramid network is used to process the input images to extract a plurality of feature pyramid layers (FPN layers). The FPN layers may be used as the input to a bottom module to extract the bottom features. Step 326 comprises concatenating and convoluting the bottom features by the first set of dynamic convolution filters to predict the peripheral points. Step 326 may be an optional step and may be performed as part of step 310 in determining the peripheral points.

Step 328 comprises generating one or more segmentation filters. In one example, the method of image processing 300 comprises generating a plurality of segmentation filters (i.e., a set of segmentation filters). In one example the set of segmentation filters are generated by adaptively fusing central features associated with central points, and peripheral features associated with peripheral points. The segmentation filters may be generated by averaging and reshaping the fused i.e., combined central features and peripheral features as indicated in step 322.

Step 330 comprises applying the segmentation filters to generate masks for each salient instance. The step of generating masks comprises convoluting the bottom features by the segmentation filters. The masks may be used to segment an image into salient instances. Step 332 comprises segmenting the one or more images based on the generated masks to identify the one or more objects within each image. The segmentation filters may be dynamic convolution filters. In one example the step of generating masks comprises convoluting the bottom features by the segmentation filters.

Step 334 comprises generating an instance agnostic saliency map from the one or more received images. The saliency map may be estimated from the extracted features from the feature extraction, e.g., the feature extraction performed in step 304. Step 336 comprises computing a saliency score based on the saliency map. The saliency score may be determined for each input image. Step 338 comprises utilizing the saliency score to update the one or more identified salient features from the segmentation filters. The saliency score is used to further update the detected objects to provide a higher confidence output. The saliency map and saliency score may be generated by a saliency module, e.g. a high level semantic guided (HSGS) saliency module. The saliency score is utilized to improve the perception of saliency and provide a more stable, robust, and improved salient instance segmentation. This results in an improved object detection method.

The method 300 may be implemented by a data processing apparatus e.g., a computing device 100 as described. The method 300 may be stored as executable instructions in a memory unit e.g., ROM 104 and may be executed by the processing unit 102.

FIG. 4 illustrates a system for image processing to identify one or more objects within an image. The system 400 can be utilised to process multiple images to identify one or more objects within these images.

The system 400 may comprise an image gateway 402 to receive one or more input images 10. The input images may be received from a camera 12. The image gateway may be a module that is configured to receive images. Each input image includes one or more salient instances, wherein each salient instance is indicative of an object. The system 400 comprises a feature extraction module 404 arranged in communication with the image gateway 402. The multi-level feature extraction module 404 is configured to identify one or more features within each image and identify one or more salient instances in the one or more received images.

A key point guided dynamic convolution module 406 is arranged in communication with the feature extraction module 404 and configured to receive the extracted features. The key points guided dynamic convolution module 406 is configured to identify a plurality of key points associated with each salient instance within each input image. The key points comprise a centre point and peripheral points of each salient instance. The module 406 is further configured to segment salient instances in each image by utilizing the plurality of key points, and;
predict one or more objects within each image based on the segmentation of each salient instance.

The key point guided dynamic convolution module 406 is configured to identify a centre point for each salient instance. The centre point may be identified in a classification head of the multi-level feature extraction module. The module 406 is further configured to generate a first set of dynamic convolution filters based on the identified centre point. The module 406 is configured to predict a minimum number of peripheral points using the dynamic convolution filters. The minimum number of peripheral points denote the limits of the instance in four directions.

The system 400 may comprise a bottom module 408. The bottom module 408 may receive the features from the multi-level feature extraction module 404 and generate bottom features for each of the received images. The bottom features are generated based on outputs from a feature pyramid network 404. The key points guided dynamic convolution module 406 is further configured to concatenate and convolute the bottom features by the first set of dynamic convolution filters to predict the peripheral points.

The system 400 further comprises a semantic guidance saliency module 410 configured to estimate a saliency map from identified features. The saliency module 410 is configured to receive the features extracted from the multi feature extraction module 404. The saliency map may be estimated from the extracted features. The features may be part of an instance agnostic stream along with the bottom module. The saliency module 410 is configured to compute a saliency score based on the saliency map.

The system 400 further comprises a score adjustment module 412 that is configured to update an original classification score from the segmentation filters with the saliency score. The saliency score is used to update the classification score. The classification score can relate to the confidence that an object i.e., an instance is identified. The system 400 comprises a prediction module 414 that is configured to update the predicted one or more objects from the key points guided dynamic convolution module. The prediction module 414 is further configured to generate an updated prediction of one or more objects within each image. The prediction module 414 is uses the updated classification score that is updated using the saliency score to improve the updated prediction.

In one example the system 400 may comprise a data processing apparatus e.g., the computing device 100. The data processing apparatus may comprise a processing unit and a memory unit (e.g., as described in relation to FIG. 1). The memory unit may comprise executable instructions, which when executed by the processing unit 102 cause the processing unit to carry out method steps 302 to 340. Optionally, method steps 200 to 214 may be executed by the system.

The system 400 for image processing may be configured to implement a model e.g., a machine learning model or an AI model. The machine learning model at a high level may comprise a backbone network, a feature pyramid network, a plurality of instance aware heads and a key point guided dynamic convolution module. These features may be in communication with each other.

The backbone network configured to receive one or more input images and extract multi-level features. The extracted features are fed into the feature pyramid network to generate feature pyramid network (FPN) layers. The plurality of instance aware heads may be attached to each feature pyramid network layer. Each instance aware head may comprise a classification head and at least two dynamic generate heads. Each head may comprise of one or more successive convolution layers with each FPN layer serving as the input. The classification head may be configured to locate centres of all salient instances supervised a ground truth centre map.

The key points guided dynamic convolution module configured to predict peripheral features of salient instances, wherein a minimum number of peripheral features are predicted. The key points module may further be configured to determine central features at or adjacent the centre points and peripheral features at or adjacent the peripheral points, and generate segmentation filters, in a differentiated patterns fusion module, based on fusing the central features and peripheral features, wherein the segmentation filters are configured to generate masks for each salient instance. The segmentation filters are configured to segment the one or more images based on the generated masks to identify the one or more objects within each image.

The key points module may be configured to compute weights for the peripheral features, wherein the weights are computed based on the distance vectors. The key points module is configured to combine the peripheral features based on the computed weights. Following the combining the key points module is configured to average the combined peripheral features with the central features and then reshaped to generate the set of segmentation filters. The key points guided dynamic convolution module is configured to concatenate the bottom features with related coordinates with the centre point and utilize the concatenated bottom features to output the masks.

The model may further comprise a bottom module and a semantic guided saliency module e.g. a high level semantic guided saliency module (HSGS module). The bottom module may be configured to: receive the FPN layers and generate bottom features. The bottom features may be used in generating the segmentation filters. The HSGS module is configured to: estimate a saliency map from identified features and compute a saliency score from the saliency map.

The model may further comprise a score adjustment module configured to update an original classification score. The model may include a prediction module configured: update the predicted one or more objects from the key points guided dynamic convolution module and generate an updated prediction of one or more objects within each image, wherein the updated prediction denoting a prediction of one or more objects present within the one or more images.

FIG. 5 illustrates an example of a machine-learning model 500 (i.e., an AI model) for image processing to identify one or more objects in an image. The model 500 may be implemented by the computing device 100 as part of a system for image processing to identify one or more objects. FIG. 5 illustrates an example pipeline of the model. The model 500 may be a key point based salient instance segmentation network.

The model 500 comprises a backbone e.g., a backbone network 502 that receives the input images 10. The input images may be single images or may be frames of a video stream.

The backbone network 502 is utilised to extract multi-level features, denoted as F₁˜F₅. These features are then fed into a feature pyramid network (FPN) 504 that is configured to generate FPN layers E₃˜E₇. Each FPN layer may be attached to instance aware heads 506. In the illustrated example, each instance aware head may comprise a classification head 508 and two dynamic generation heads 510, 512. Optionally each instance aware head 506 may also comprise a box head. In one example each head 506 may comprise four successive 3×3 convolution layers, with the corresponding FPN layer E₃˜E₇ serving as an input (as shown in FIG. 5).

In one example the classification head 508 and box head may follow the design in the object detector FCOS (fully convolutional one stage object detection). The classification head is configured to locate the centres of all salient instances. The classification head 508 may be supervised by a ground truth centre map, where the labels are 1 inside the central regions of salient instances and 0 elsewhere. For each located centre, the box head estimates the corresponding bounding box by regressing the distance from the centre to the four box sides. The bounding box only serves for non-maximum suppression (NMS) and does not generate any region of interest (RoI) to limit the input region for segmentation, which is different from those traditional RoI-based models.

The two dynamic generation heads 510, 512 generate parameters to construct dynamic convolutional filters for different purposes, i.e., locating peripheral points and segmenting instances. The outputs of these two heads are denoted as DPϵ [symbol] ^{C}^{_{DP}}^{×H}^{ₖ}^{×W}^{ₖ} and DSϵ [symbol] ^{C}^{_{DS}}^{×H}^{ₖ}^{×W}^{ₖ}, respectively, where Hₖ and Wₖ represent the spatial size of the corresponding FPN layer Eₖ, and C_{DP} and C_{DS} signify the number of channels.

The model 500 may further comprise an instance agnostic stream (i.e., instance agnostic path) with a bottom module 520 and a semantic guidance saliency module 522. The module 522 may also be called a High-Level Semantic Guidance Saliency (HSGS) module, as shown in FIG. 9. The model may also comprise a score adjustment module 524 that is configured to receive the output of the semantic guidance saliency module 522. The model 500 may further comprise a prediction module 526 that outputs a final prediction of objects.

For the instance-agnostic stream, the bottom module follows the same architecture as in [1], where FPN layers E₃˜E₅ are used as the input to form the bottom features Bϵ [symbol] ^{C}^{_{B}}^{×H}^{_{B}}^{×W}^{_{B}}. In parallel with the bottom module, the proposed HSGS module also takes E₃-E₅ as the input and estimates a saliency map S.

The model 500 may further comprise a key point guided dynamic convolution module mechanism (KGDC) 530. The general functions of the KGDC module 506 will now be described, with detailed functions described later. The features B and the results of all heads 506 are fed into the KGDC module 530. Specifically, for an instance, module 530 is configured to identify the central features from DP to generate a set of dynamic convolutional filters. These filters are utilised to convolute the bottom features B and predict the map of peripheral points. Next, the central and peripheral features may be selected from DS are fused to form segmentation filters i.e., another set of dynamic convolution filters with the help of the proposed Differentiated Patterns Fusion (DPF) module 532. Finally, a mask can be achieved by convoluting features B with this new filter set i.e., the mask for segmentation can be achieved by convoluting the bottom features with the segmentation filters. The DPF module 532 may be part of the KGDC mechanism i.e., module 530. The final score i.e., final prediction from the prediction module 526 of each predicted instance is updated by a saliency score, which is computed based on the saliency map S in the semantic guidance saliency module 522. The score adjustment may be performed in the score adjust module 524.

The KGDC module 530 will be described in more detail and with reference to FIGS. 6, 7 and 8. In prior art systems only features at the centre of an instance are used to generate dynamic convolution filters, based on the assumption that central features are often most representative of a whole instance. Once common prior art approach for instance segmentation is to introduce the four vertices of the bounding box. However, since these vertices are often outside the actual region of the instance and cover patterns not belonging to the instance, it is unreasonable to use these features to generate dynamic convolutional filters.

FIG. 6 includes four sub figures a), b), c) and d). FIG. 6 a) illustrates an input image with a salient instance i.e., the truck 600. FIG. 6b) illustrates the bounding box for vertices 602. The bounding box vertices 602 covers patterns or features that are not part of the instance 600. The FIG. 6b) illustrates a prior art bounding box approach that is not efficient and can create increased computational load due to increased features around the object. The model 500 uses peripheral points referring to the points that are distributed around the instance boundary. Peripheral points may be points that are define the outer boundary as shown in FIG. 6c). The features at these points cover distinct patterns with the central features and offer more explicit geometrical constraints than bounding box vertices. However, a dense sampling of these points, e.g., as shown in FIG. 6c) is redundant and inevitably a very time-consuming and clumsy operation.

The model 500 is configured to determine and utilise a minimum number of peripheral points. The model 500 is configured to determine four peripheral points 610, 612, 614, 616, the four peripheral points defining the upper most point, bottom most point, left most point and right most point of an instance. For example, as shown in FIG. 6d) the points with maximum or minimum x- and y-coordinates within the instance region, namely, the leftmost, rightmost, topmost, and bottommost points are determined and utilised.

For any given instance, all its pixels will necessarily be located to the right of the point with the minimum x-coordinate, to the left of the point with the maximum x-coordinate, above the point with the minimum y-coordinate, and below the point with the maximum y-coordinate. Therefore, regardless of the irregularity of an instance, these four peripheral points can completely delineate it. these points are the farthest from the centre in horizontal and vertical directions, and are typically distant from one another, thereby covering as many different patterns as possible at a minimal sampling cost. Simultaneously, these points can provide necessary geometrical information because they incorporate the rough coverage of the instance, ensuring the macro-level accuracy of the mask. FIG. 7 illustrates an example of a mask i.e., a segmentation box 700 that is determined based on four peripheral points. The segmentation box reduces error of incorporating other instances as compared to the traditional bounding box of FIG. 6b).

Generally, the centre is well-defined, and the segmentation is performed around it. However, the outer parts remain ambiguous, complicating the decision of ‘where to stop’ when the convolutions begin from the centre. The model 500 alleviates this issue by determining peripheral points that can imply coverage, allowing preliminary geometrical information to be infused into the dynamic convolutional filters. The model 500 utilises a minimum number of peripheral points e.g., four peripheral points to define the instance.

The KGDC module 530 is configured to determine and utilise the features at the centre and peripheral points to generate dynamic convolutional filters to segment the instance. The KGDC module 530 is configured to locate peripheral points, select central and peripheral features and generate segmentation filters i.e., dynamic convolutional filters, and perform dynamic convolutions for segmentation.

The key points guided dynamic convolution module 530 is configured to apply a dynamic convolution method that establishes a one-to-one correspondence between dynamic convolution filter sets and individual instances, such that groups are naturally formed.

Specifically, for all N center locations predicted by the classification head {cᵢ|iϵ{1, 2, . . . , N}}, the module 530 is configured to select the corresponding features from DP, denoted as {dpᵢ|iϵ{1, 2, . . . , N}}ϵ [symbol] ^{C}^{_{DP}}, and reshape them to dynamic convolutional filter sets {dcᵢ^{p}|iϵ{1, 2, . . . , N}}, which are used to predict the map of peripheral points. The key points guided dynamic convolution module 530 is configured to use a combination of two 1×1 dynamic convolution layers and two 3×3 non-dynamic dilated convolution layers, in which the dynamic convolutions identify the target instance, and then the non-dynamic dilated convolutions locate the peripheral points of it. Both dynamic convolutional filters are 1×1, so only require very few parameters. The combination of a small dynamic convolution layers and two non-dynamic dilated convolution layers reduces the computational load as compared to current known approaches such as for example using 3×3 dynamic convolution layers.

For the module 530, the whole procedure to predict the map of peripheral points for instance i, Pᵢϵ [symbol] ^{4×H}^{_{P}}^{×W}^{_{P}}, can be formulated by:

$${P}_{i} = {Conv}_{3}^{2} ( {Conv}_{3}^{2} ( {DC}_{i}^{p , 2} ( {DC}_{i}^{p , 1} ( Cat ( B , RC ) ) ) ) ) , \qquad ( 1 )$$

where B denotes the bottom features, RC is the map of related coordinates to the center, which can further indicate the target instance. Conv₃² is a 3×3 convolutional layer with a dilation rate of 2, DCᵢ^{p,1} and DCᵢ^{p,2} are the two 1×1 dynamic convolutions with the filter set dcᵢ^{p}, Cat represents concatenation. Each channel of Pᵢ, denoted as Pᵢ^{j}ϵ [symbol] ^{1×H}^{_{P}}^{×W}^{_{P}}, is the predicted heatmap for each of the four peripheral points.

During training, instead of using a map with only a single positive pixel in each channel for supervision, Gaussian heatmaps with peaks at the peripheral points are applied and denoted as Pᵢ^{gt}ϵ [symbol] ^{1λH}^{_{P}}^{×W}^{_{P}} Each channel is denoted as Pᵢ^{gt,j}, is the heatmap for one of the ground-truth peripheral points. The values of Pᵢ^{gt,j} can be computed by:

$${P}_{i}^{gt , j} ( x , y ) = {e}^{- \frac{{( x - {x}_{i}^{j} )}^{2} + {( y - {y}_{i}^{j} )}^{2}}{2 {σ}_{i}^{2}}} , \qquad ( 2 )$$

where jϵ{1, 2, 3, 4} is the channel index, corresponding to one of the peripheral points. x and y are the horizontal and vertical coordinates respectively, and (xᵢ^{j}, yᵢ^{j}) signifies the ground-truth location of the peripheral point. σᵢ represents the standard deviation for this Gaussian peak, which is determined by the instance size so that larger instances will have larger peaks. σᵢ can be computed by:

$${σ}_{i} = \frac{\sqrt{{h}_{i} \times {w}_{i}}}{μ} , \qquad ( 3 )$$

where hᵢ and wᵢ are the height and the width of the instance, and μ is a hyper-parameter to adjust the scale of the peak, empirically set to be 48.

Using Gaussian heatmaps to replace strict binary classification supervision can make learning more manageable. In the binary way, a ground-truth peripheral point and its adjacent point have totally different labels, but they often look very similar and can serve similar functions in our task, which is very confusing. By contrast, in the heatmap way, the labels of peripheral points and their neighbours are very close, thus alleviating the confusion. At the same time, the value increases when approaching the ground-truth point, which encourages the prediction to get closer to it.

After locating the centre point and the peripheral points the key points guided dynamic convolution (KGDC) module 530 configured to determine features at these key points. The features at these key points i.e., the central features and the peripheral features are used to generate dynamic convolution filters for segmentation i.e., segmentation filters. The KGDC module 530 is configured to pick the central features i.e., feature at or adjacent the centre point directly from DS, denoted as dsᵢ^{c}ϵ [symbol] ^{C}^{_{DS}}. For the peripheral points, since each corresponds to a heatmap, the KGDC module 530 is configured to calculate a weighted average across DS the heatmap responses as weights to generate peripheral features {dsᵢ¹, dsᵢ², dsᵢ³, dsᵢ⁴}ϵ [symbol] ^{C}^{_{DS}}:

$${ds}_{i}^{j} = \frac{{\sum }_{x = 1}^{{W}_{k}} {\sum }_{y = 1}^{{H}_{k}} [ {\tilde{P}}_{i}^{j} ( x , y ) \times DS ( x , y ) ]}{{\sum }_{x = 1}^{{W}_{k}} {\sum }_{y = 1}^{{H}_{k}} {\tilde{P}}_{i}^{j} ( x , y )} . \qquad ( 4 )$$

Here, \tilde{P}ᵢ^{j}ϵ [symbol] ^{C}^{_{DS}}^{×H}^{ₖ}^{×W}^{ₖ} is derived from Pᵢ^{j}ϵ [symbol] ^{1×H}^{_{P}}^{×W}^{_{P}} through spatial downsampling and channel broadcasting to align the dimensions with DS.

The KGDC module 530 comprises a Differentiated Patterns Fusion (DPF) module 532 that is used to fuse central features and peripheral features. FIG. 8 illustrates an example structure of the DPF module 532. FIG. 8 also illustrates the functions of the DPF module which will be described below.

In the implementation, the weights for combining peripheral features are computed based on the difference between them and the central features. The difference vector between the central features dsᵢ^{c} and one of the peripheral features dsᵢ^{j} is given by:

$${D}_{i}^{j} = {( Θ ( {ds}_{i}^{c} ) - Φ ( {ds}_{i}^{j} ) )}^{2} , \qquad ( 5 )$$

where θ and Φ are two linear projection layers.

Next, the DPF module 532 is configured to convert the difference vectors to a set of weights Wᵢϵ [symbol] ^{4×C}^{_{DS}}, formulated by:

$${W}_{i} = soft max ( Cat ( Ψ ( {D}_{i}^{1} ) , Ψ ( {D}_{i}^{2} ) , Ψ ( {D}_{i}^{3} ) , Ψ ( {D}_{i}^{4} ) ) ) , \qquad ( 6 )$$

where softmax is the softmax function along the first dimension, and P is another linear projection layer. It is noted that all linear projections with the same notation are weight-shared. Each value in Wᵢ reflects the difference between the central features and the peripheral features in its position. By element-wise multiplying them with the peripheral features, the DPF module 532 is configured to take apart the components that are distinct from the central features.

Thus, the fused peripheral features dsᵢ^{p}ϵ [symbol] ^{C}^{_{DS}} can be achieved by using Wᵢ to weighted average the four peripheral features:

$${ds}_{i}^{p} = \frac{{\sum }_{j = 1}^{4} ( {W}_{i}^{j} ⊗ {ds}_{i}^{j} )}{{\sum }_{j = 1}^{4} {W}_{i}^{j}} , \qquad ( 7 )$$

where Wᵢ^{j}ϵ [symbol] ^{C}^{_{DS}} denotes the j-th row of Wᵢ, ⊗ signifies the operation of element-wise multiplication.

Finally, the dynamic convolutional filters dcᵢ^{s} are achieved by averaging dsᵢ^{p} with dsᵢ^{c} and then reshaping the result, which is given by:

$${dc}_{i}^{s} = Reshape ( \frac{{ds}_{i}^{p} + {ds}_{i}^{c}}{2} ) , \qquad ( 8 )$$

where Reshape is to reshape the output to be three 1×1 dynamic convolutional filters.

The functions above are illustrated in FIG. 8. The output of the DPF module 532 is a set of segmentation filters that are used to segment instances.

In one example the segmentation process may be similar to the CondInst network. Before the first dynamic convolutional layer, the bottom features B are concatenated with the related coordinates toward the center location RC, which is proved to be effective for providing positional information and improving performance. The two subsequent dynamic convolutional layers take the output from the previous layer without concatenation. The output of the last layer is the predicted mask:

$${M}_{i} = Up ( {DC}_{i}^{s , 3} ( {DC}_{i}^{s , 2} ( {DC}_{i}^{s , 1} ( Cat ( B , RC ) ) ) ) ) . \qquad ( 9 )$$

Herein, MᵢϵR^{H×W} represents the predicted mask, where H×W denotes the spatial dimensions, equivalent to that of the input image. DCᵢ^{s,1}, DCᵢ^{s,2}, and DCᵢ^{s,3} are the three dynamic convolutional layers with the filter set dcᵢ^{s}, Up represents upsampling that aligns the spatial sizes. The predicted mask is the predicted instance following the output of the segmentation filters.

Sometimes the centres of salient or non-salient instances do not appear to be obviously different. Whether an instance is salient or not depends on its whole appearance and its surroundings, but these things may not be concentrated in the classification head. The model 500 comprises semantic guidance saliency module 522 whose trigger timing is not in the very early stage of the network, but at the end of it to correct the results in a plug-in way. The saliency module 522 is used to predict an instance-agnostic saliency map for the input image, which is then used to compute a saliency score for each instance and adjust its original confidence score given by the classification head. FIG. 9 illustrates an example of the semantic guidance saliency module 522 and its structure.

The semantic guidance saliency module 522 uses the FPN layers E₃ to E₅ as its inputs. Considering that in SOD, when the low-level feature maps are gradually fused, the high-level semantics can be diluted. Hence the saliency module 522 comprises high-level semantic guidance streams that are added to it. The guidance features G are refined from E₅, which contain the most abstract semantics, by deploying a CBAM, as shown in FIG. 9. CBAM comprises channel and spatial attention mechanisms, where the former allocates higher weights to channels contributing substantially to the overall information, and the latter identifies and assigns higher weights to spatial locations bearing more valuable information.

CBAM is trained to prioritize channels and spatial locations possessing key saliency information and is supervised by the ground truth saliency map. This makes the output features more appropriate as the high-level semantic guidance features. As shown in FIG. 9, when merging the FPN features level by level, guidance features are added every time to prevent the global information from vanishing:

$$Fuse ( {E}_{k + 1} , {E}_{k} ) = Conv ( Cat ( Up ( {E}_{k + 1} ) , {E}_{k} ) ) + Up ( G ) , \qquad ( 10 )$$

where Conv is a convolutional layer. Finally, the saliency map SϵR^{H×W} is predicted by:

$$S = Up ( Sig ( Conv ( Conv ( Fuse ( Fuse ( {E}_{5} , {E}_{4} ) , {E}_{3} ) ) ) ) ) . \qquad ( 11 )$$

where Sig is a sigmoid function.

The sematic guidance saliency module 522 is configured to compute the saliency score SalScoreᵢ for each instance by:

$${SalScore}_{i} = \sqrt{\frac{{\sum }_{x = 1}^{W} {\sum }_{y = 1}^{H} [ {M}_{i} ( x , y ) \times S ( x , y ) ]}{{\sum }_{x = 1}^{W} {\sum }_{y = 1}^{H} {M}_{i} ( x , y )}} . \qquad ( 12 )$$

The saliency score is computed after achieving the predicted saliency map S. The saliency map S is utilised in determining the saliency score and the saliency score is determined based on the computed saliency map.

This equation calculates how much part of an instance is inside the salient regions. If the entire instance is in the salient region, the saliency score will be 1, while if very little or none is in the salient regions, the saliency score will be close to 0. The score adjustment module 524 is configured to update the original classification score. Finally, the final score FinalScoreᵢ for each instance is achieved by multiplying its original classification score ClsScoreᵢ and this saliency score:

$${FinalScore}_{i} = {ClsScore}_{i} \times {SalScore}_{i} . \qquad ( 13 )$$

The equation (13) may be executed in the score adjustment module 524. Optionally, the score adjustment module 524 may be part of the sematic guidance saliency module 522. A prediction module 526 is configured to: update the predicted one or more objects from the key points guided dynamic convolution module and generate an updated prediction of one or more objects within each image. This is shown in FIG. 5.

The loss function L includes five terms: the classification loss L_{cls}, the regression loss (of bounding boxes) L_{reg}, the peripheral point localization loss Lₚ, the mask loss Lₘₐₛₖ, and the saliency loss Lₛₐₗ, formulated by:

$$L = {L}_{cls} + {L}_{reg} + {L}_{p} + λ {L}_{mask} + {L}_{sal} , \qquad ( 14 )$$

where L_{cls} and L_{reg} are totally the same as in FCOS. Lₚ and Lₘₐₛₖ are dice losses, Lₛₐₗ is a focal loss and A is set to be 5.

In a further example form the system 400 may comprise a machine-learning model for image processing to identify one or more objects in an image, in particular for the application of method 200 or 300. The model may cause the system 400 to execute the method steps as described.

The system and the model used for image processing described herein is advantageous because they provide a region of interest free salient instance segmentation method, which determines key points to generate masks for segmentation. The method provides a robust, and accurate method for image processing and object recognition. The model, system and method may perform competitively compared to current state of the art methods.

The system, method and model described herein is advantageous because peripheral points are used and calculated based on the centre points. The peripheral points and centre points are used to generate segmentation filters i.e., dynamic convolution filters. This is advantageous because more comprehensive and diverse patterns can be captured. Further the model and system can be facilitated to perform more targeted feature learning in a geometrically constrained manner. The method described herein provides an improved method for identifying salient instances in images.

The addition of the DPF module is advantageous because the module is designed to measure the effects of different key points adaptively to ensure the comprehensiveness of the final segmentation filters. The semantic saliency module is advantageous because as it is used to bridge the relationship between saliency and instances.

The described system and method for image processing is advantageous because they leverage multiple key point features (central features and peripheral features) to aid in salient instance segmentation, serving as an effective geometric constraint. Applications of the described model span from image captioning to scene understanding, where the analysis of salient instances is crucial.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods, models and systems described herein are either wholly implemented by computing system or partly implemented by computing systems then any appropriate computing system architecture may be utilised. This will include standalone computers, network computers and dedicated hardware devices. Where the terms “computing system” and “computing device” are used, these terms are intended to cover any appropriate arrangement of computer hardware capable of implementing the function described.

The term module as described herein may be a software module or a hardware module or a combination thereof. The modules may be discrete software code blocks or code elements. The modules may be individual software applications that may be configured to perform the functions described herein and interact with each other. The software modules together may define a software program or software application.

Alternatively, the modules as described herein may be hardware modules e.g., integrated circuits or ASICs or a combination of digital circuits. The modules may be processors e.g., microprocessors or microcontrollers or FPGAs or other suitable processor units that may be arranged in electronic communication.

Any reference to prior art contained herein is not to be taken as an admission that the information is common general knowledge, unless otherwise indicated.

Also, it is noted that the embodiments may be described as a method (i.e., a process) that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A method may correspond to a process, a function, a procedure, a subroutine, a subprogram, etc., in a computer program. When a method corresponds to a function, its termination corresponds to a return of the function to the calling function or a main function.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A computer-implemented method of image processing to identify one or more objects in an image comprising:
receiving one or more input images, wherein each input image includes one or more salient instances, wherein each salient instance is indicative of an object,
identifying a plurality of key points associated with each salient instance within each input image,
segmentation of salient instances in each image by utilizing the plurality of key points, wherein the key points comprise a centre point and peripheral points of each salient instance, and;
predicting one or more objects within each image based on the segmentation of each salient instance.

2. The method of claim 1, further comprising the steps of:
performing a multi-level feature extraction on the received images to extract multiple features, and
processing the extracted features with multiple instance aware heads.

3. The method of claim 2, wherein the step of identifying a plurality of key points comprises:
identifying a centre point for each salient instance,
generate a first set of dynamic convolution filters based on the identified centre point, and;
predict a plurality of peripheral points using the dynamic convolution filters.

4. The method of claim 3, comprises predicting a minimum number of peripheral points per instance, wherein the minimum number of peripheral points denote the limits of the instance in four directions.

5. The method of claim 1, comprising the step of generating bottom features for each of the received images, wherein the bottom features are generated based on outputs from a feature pyramid network.

6. The method of claim 5, wherein the bottom features are concatenated with relative coordinates to the centre point and convoluted by the first set of dynamic convolution filters to predict the peripheral points.

7. The method of claim 5, comprising the steps of:
generating a plurality of segmentation filters,
applying the segmentation filters to generate masks for each salient instance, and
segmenting the one or more images based on the generated masks to identify the one or more objects within each image.

8. The method of claim 7, wherein the step of generating masks comprises convoluting the bottom features by the segmentation filters.

9. The method of claim 7, wherein the segmentation filters are generated by adaptively fusing central features associated with central points, and peripheral features associated with peripheral points.

10. The method of claim 4, wherein the minimum number of peripheral points is four peripheral points, the four peripheral points defining the upper most point, bottom most point, left most point and right most point of an instance.

11. The method of claim 9, comprising the additional steps of:
selecting central features at or adjacent the centre point identifying peripheral features at or adjacent the peripheral points,
computing distance vectors between the peripheral features and the central features,
computing weights for the peripheral features, wherein the weights are computed based on the distance vectors,
determining a weighted average of the peripheral features based on the computed weights, and;
averaging the combined peripheral features with the central features and then reshaping the averaged values to generate the set of segmentation filters.

12. The method of claim 11, comprising:
generating an instance agnostic saliency map the one or more received images,
computing a saliency score for each instance, and;
utilizing the saliency score to update the one or more identified objects.

13. A system for image processing to identify one or more objects in an image, comprising:
an image gateway to receive one or more input images, wherein each input image includes one or more salient instances, wherein each salient instance is indicative of an object,
a multi-level feature extraction module configured to identify one or more features within each image and process the extracted features with multiple instance aware heads,
a key points guided dynamic convolution module configured to:
identify a plurality of key points associated with each salient instance within each input image, wherein the key points comprise a centre point and peripheral points of each salient instance,
segment salient instances in each image by utilizing the plurality of key points, and;
predict one or more objects within each image based on the segmentation of each salient instance.

14. A system of claim 13, wherein the key points guided dynamic convolution module configured to:
identify a centre point for each salient instance,
generate a first set of dynamic convolution filters based on the identified centre point,
predict a minimum number of peripheral points using the dynamic convolution filters, and;
wherein the minimum number of peripheral points denote the limits of the instance in four directions.

15. A system of claim 14, comprising a bottom module, the bottom module configured to generate bottom features for each of the received images, wherein the bottom features are generated based on outputs from a feature pyramid network and;
the key points guided dynamic convolution module is further configured to concatenate and convolute the bottom features by the first set of dynamic convolution filters to predict the peripheral points.

16. The system of claim 15, wherein key points guided dynamic convolution module further configured to:
generate a plurality of segmentation filters,
apply the segmentation filters to generate masks for each salient instance, and;
segment the one or more images based on the generated masks to identify the one or more objects within each image.

17. A system of 16, comprising
a semantic saliency module configured to:
estimate a saliency map from identified features,
compute a saliency score based on the saliency map,
a score adjustment module configured to update an original classification score,
a prediction module configured to:
update the predicted one or more objects from the key points guided dynamic convolution module and;
generate an updated prediction of one or more objects within each image.

18. A system of 17, wherein the key points guided dynamic convolution module is configured to:
select central features at or adjacent the centre point,
identify peripheral features at or adjacent the peripheral points,
compute distance vectors between the peripheral features and the central features,
determine a weighted average of the peripheral features based on these distance vectors,
the key points guided dynamic convolution module further comprises a differentiated patterns fusion module that is configured to:
compute weights for the peripheral features, wherein the weights are computed based on the distance vectors,
combine the peripheral features based on the computed weights,
average the combined peripheral features with the central features and then reshaped to generate the set of segmentation filters, and;
the key points guided dynamic convolution module is configured to concatenate the bottom features with related coordinates with the centre point and utilize the concatenated bottom features to output the masks.

19. A machine-learning model for image processing to identify one or more objects in an image for use in the method of claim 12, comprising:
a backbone network configured to receive one or more input images and extract multi-level features from the received input images,
a feature pyramid network (FPN), wherein the extracted features are fed into the feature pyramid network to generate feature pyramid network (FPN) layers,
a plurality of instance aware heads are attached to each feature pyramid network layer, wherein each instance aware head comprises a classification head and at least two dynamic generate heads, each head comprises one or more successive convolution layers with each FPN layer serving as the input,
wherein the classification head is configured to locate centres of all salient instances supervised a ground truth centre map,
a key points guided dynamic convolution module configured to:
predict peripheral features of salient instances, wherein a minimum number of peripheral features are predicted,
determine central features at or adjacent the centre points and peripheral features at or adjacent the peripheral points,
generate segmentation filters, in a differentiated patterns fusion module, based on fusing the central features and peripheral features, wherein the segmentation filters are configured to generate masks for each salient instance,
the segmentation filters are configured to segment the one or more images based on the generated masks to identify the one or more objects within each image,
a bottom module and a semantic guided saliency module that are arranged in parallel to the key points guided dynamic convolution module, wherein the bottom module and the semantic guided saliency module define an instance agnostic stream of the model,
wherein the bottom module is configured to:
receive the FPN layers,
generate bottom features,
wherein the semantic guided saliency module is configured to:
estimate a saliency map from identified features,
compute a saliency score based on the saliency map,
a score adjustment module configured to update an original classification score, and;
a prediction module configured:
update the predicted one or more objects from the key points guided dynamic convolution module,
generate an updated prediction of one or more objects within each image, wherein the updated prediction denoting a prediction of one or more objects present within the one or more images.
